(19) United States
(12) Patent Application Publication
(10) Pub. No.: US 2026/0208598 A1
(43) Pub. Date: Jul. 23, 2026

(54) DRIVE DEVICE FOR AN ELECTRIC VEHICLE, ELECTRIC VEHICLE AND METHOD FOR OPERATING A DRIVE DEVICE IN AN ELECTRIC VEHICLE

(71) Applicant: VALEO EAUTOMOTIVE GERMANY GMBH, Erlangen (DE)

(72) Inventors: Marco ZIMMERMANN, Erlangen (DE); Jingpeng GUAN, Erlangen (DE)

(73) Assignee: VALEO EAUTOMOTIVE GERMANY GMBH, Erlangen (DE)

(21) Appl. No.: 19/140,221

(22) PCT Filed: Dec. 20, 2023
(86) PCT No.: PCT/EP2023/086944

§ 371 Date: Jun. 17, 2025

(30) Foreign Application Priority Data
Dec. 22, 2022 (DE) 10 2022 134 566.1

(51) Int. Cl. B60L 15/02; B60L 15/20; B60L 50/51; H02P 21/00; H02P 21/22; H02P 21/26

(52) U.S. Cl. CPC B60L 15/025; B60L 15/20; B60L 50/51; H02P 21/0021; H02P 21/22; H02P 21/26; B60L 2210/42; B60L 2240/423; B60L 2240/425

(57) ABSTRACT

Drive device for an electric vehicle, including an electric machine with a stator and a rotor, and a temperature determination device. The electric machine has machine characteristics, according to which one value of a torque (T) is assigned to each operating point being a pair of values of the d- and the q-component, the power converter device being configured to receive the torque command and to determine a pair of setpoints (i_{d}^{*}, i_{q}^{*}) for the d- and the q-component corresponding to one operating point that is assigned to the desired torque (T*). Upon receiving the first and second information states, the pair of setpoints is determined according to a first and second operating modes. The power converter device being configured to generate the multiphase current depending on the pair of setpoints.

### FIELD OF THE INVENTION

The present invention relates to a drive device for an electric vehicle. Aside, the invention relates to an electric vehicle and to a method for operating a drive device in an electric vehicle.

### BACKGROUND OF THE INVENTION

Electric machines with a rotor and a stator, in which the stator is supplied by a power converter device, are widely known, in particular as a drive device for an electric vehicle. The multiphase current can be represented by space vector having a direct-axis-component (d-component) and a quadrature-axis-component (q-component) in a rotor flux oriented coordinate system. Therein, setpoints for the d-component and the q-component can be chosen by the power converter device within a certain degree of freedom so as to obtain a specific torque depending on a torque command received by the power converter device. In general, it is desirable to the drive device based on a maximum torque per stator current (MTPC) strategy, which allows high efficiency resulting in a high range of an electric vehicle equipped with the drive device. Therein, the MTPC strategy minimizes stator copper losses, which are usually the dominating losses in the motor.

For example, U.S. Pat. No. 5,498,945 A discloses an induction motor control system used in an electrically-driven vehicle. An inverter controlled by a motor controller creates voltages for three phases of an induction motor. A torque command is issued to the motor controller from a vehicle-level controller. The motor controller determines desired quadrature-axis current and direct-axis current depending on the torque command. The desired currents are provided with an approximated direct-axis current being lower than a direct-axis current based on a peak-torque-per-ampere relationship.

Such drive devices have a non-neglectable portion of rotor losses. Particularly, in cases, where the rotor is merely cooled passively, high rotor temperatures can lead to less availability and result in derating. Then, operating the drive device based on an MTPC strategy cannot be upheld and the current supplied to the stator has to be reduced so that a desired torque represented by the torque command cannot be achieved.

### SUMMARY OF THE INVENTION

It is an object of the invention to improve operation of a drive device in an electric vehicle, particularly to increase its performance and/or to improve efficiency by having lower losses.

According to the invention, this object is solved by a device for an electric vehicle, comprising: an electric machine with a stator and with a rotor being arranged rotatably relative to the stator; a temperature determination device configured to determine a temperature information being representative of a temperature of the rotor, the temperature information having at least two information states, a first one of the information states being representative of a first temperature and a second one of the information states being representative of a second temperature being higher than the first temperature; and a power converter device configured to provide a multiphase current to the stator, having an input for a torque command representing a desired torque to be provided by the rotor and being operable according to a first operating mode and according to a second operating mode, the multiphase current being representable by a space vector with a d-component and a q-component in a rotor flux oriented coordinate system; the electric machine having machine characteristics, according to which one value of a torque provided by the rotor is assigned to each one of multiple operating points, each operating point being a pair of values of the d-component and the q-component, the power converter device being configured to receive the torque command and to determine a pair of setpoints for the d-component and the q-component corresponding to one of the operating points that is assigned to the desired torque, wherein, upon receiving the first information state, the pair of setpoints is determined according to the first operating mode, and, upon receiving the second information state, the pair of setpoints is determined according to the second operating mode, in which the setpoint for the d-component has a higher value than the setpoint for the d-component that is determined in the first operating mode at the desired torque and in which the setpoint for the q-component has a lower value than the setpoint for the q-component that is determined in the first operating mode at the desired torque, wherein the power converter device is further configured to generate the multiphase current depending on the pair of setpoints.

The drive device for an electric vehicle according to the invention comprises an electric machine. The electric machine comprises a stator and a rotor. The rotor is arranged rotatably relative to the stator.

The drive device further comprises a temperature determination device. The temperature determination device is configured to determine a temperature information. The temperature information is representative of a temperature of the rotor. The temperature information has at least two information states. A first one of the information states is representative of a first temperature. A second one of the information states is representative of a second temperature. The second temperature is higher than the first temperature.

The drive device further comprises a power converter device. The power converter device is configured to provide a multiphase current to the stator. The multiphase current is representable by a space vector with a d-component and a q-component in a rotor flux oriented coordinate system. The power converter device has an input for a torque command. The torque command represents a desired torque to be provided by the rotor. The power converter device is operable according to a first operating mode and according to a second operating mode.

The electric machine has machine characteristics. According to the machine characteristics one value of a torque provided by the rotor is assigned to each one of multiple operating points. Each operating point is a pair of values of the d-component and the q-component. The power converter is configured to receive the torque command. The power converter is further configured to determine a pair of setpoints for the d-component and the q-component. The pair of setpoints corresponds to one of the operating points that is assigned to the desired torque. Upon receiving the first information state, the pair of setpoints is determined according to the first operating mode.

Upon receiving the second information state, the pair of setpoints is determined according to the second operating mode. In the second operating mode, the setpoint for the d-component has a higher value than the setpoint for the d-component that is determined in the first operating mode at the desired torque. Further, in the second operating mode, the setpoint for the q-component has a lower value than the setpoint for the q-component that is determined in the first operating mode at the desired torque. The power converter device is further configured to generate the multiphase current depending on the pair of setpoints.

The invention is especially based on the consideration that rotor losses are mainly determined by the q-component of the space vector. I.e., at the same torque, by decreasing the q-component and increasing the d-component, lower rotor losses can be achieved. As the machine characteristics of the electric machine have multiple operating points, which result in the desired torque described by the torque command, it is proposed to use a pair of setpoints that cause the desired toque, have a lower q-component and correspondingly a higher d-component in the second operating mode covering the higher second temperature.

Thus, when the rotor temperature is relatively high, a further increase of the rotor temperature or the rotor losses, respectively, can be reduced or prevented without reducing the torque, advantageously. Although such a control strategy may cause higher stator losses, the proposed control strategy is particularly useful in cases, where the rotor usually heats up more than the stator, e.g., due to design restrictions caused by cooling difficulties of the rotor in comparison to the stator. In other words, when the rotor temperature is the limiting factor for providing the desired torque, the invention provides a possibility to maintain or reach the desired torque, wherein a higher amount of stator losses is accepted, if necessary.

In detail, the electric machine may comprise a shaft connected in a torque-proof manner to the rotor. The electric machine may also comprise a machine housing. The electric machine may further comprise bearings supporting the shaft rotatably and particularly being affixed to the machine housing. An air gap may be formed between the rotor and the stator. Preferably, the electric machine comprises a cooling device configured to actively cool the stator, e.g., by a cooling fluid. The rotor may be passively cooled by a thermal path via the shaft and the bearings to the stator housing and/or via the air gap and the stator to the stator housing. Therein, by the inventive control strategy, the temperature of the rotor can be reduced although the rotor is merely cooled passively. Furthermore, the drive device according to the invention may comprise a rotor position sensor configured to determine a rotor angle information representing an angular position of the rotor. The rotor position sensor may be disposed inside the electric machine.

The term “d-component” refers to a direct-axis-component and the term “q-component” refers to a quadrature-axis-component of the space vector. Preferably, the multiphase current is a three-phase or six-phase current. The power converter device may comprise a power section for providing the multiphase current to the electric machine. Desirably, the power section may comprise a DC link configured to be connected to an external DC voltage source, such as a vehicle high-voltage battery. The power section may be configured to obtain a DC voltage of at least 200 V, preferably at least 400 V, more preferably at least 800 V. The power section may comprise an inverter circuit. The inverter circuit may comprise a plurality of semiconductor switching elements, e.g., insulated gate bipolar transistors (IGBT) or insulated gate field-effect transistors (IGFET) such as silicon carbide-based metal-oxide-semiconductor field-effect transistors (SiC-MOSFET) or a gallium-nitride-based field-effect transistors (GaN-FET). Preferably, the switching elements are interconnected to a half-bridge for each phase of the multiphase current.

The power converter device may comprise a current measurement section configured to determine a current information representing the multiphase current. Desirably, the power converter device comprises a control section for determining the setpoints. The control section may obtain the torque command from the input and to receive the temperature information. Preferably, the control section is further configured to generate switching signals for turning on and off the switching elements of the power section. The control section may comprise a transformation subsection configured to transform the current information and a transformation angle into an actual d-current value and into an actual q-current value. The control section may comprise a determination subsection configured to determine the pair of setpoints. Particularly, the determination subsection is configured to determine the pair of setpoints depending on the temperature information and the torque command.

The control section may further comprise a regulator subsection configured to generate the switching signals depending on the pair of setpoints and the actual d-current value and the actual q-current value. The regulator subsection may determine the transformation angle based on the rotor angle information or sensorless. Preferably, the regulator subsection is configured to generate the switching signals based on field-oriented control. The regulator subsection may also be configured to generate switching signals based on a transformation being inverse to the transformation performed by the transformation subsection, particularly based on the transformation angle.

Further, the drive device may comprise a gear box being mechanically coupled to the shaft. Exemplarily, the gear box may connect the shaft of the electric machine via one or multiple gears with a wheel hub. Preferably, the electric machine, the temperature determination device and the power converter device, and optionally the gear box, are arranged within an integral housing.

With regard to the drive device according to the invention, the machine characteristics may have MTPC operating points assigned to a respective value of the torque. In other words, there exist operating points for each value of the torque which fulfil a maximum-torque-per-current criterion with regard to the multiphase current. At the MTPC operation points, the copper losses inside the stator are minimized. Note that the MTPC criterion does not take rotor and iron losses into account. Preferably, the MTPC operating points comprise those operating points, at which the torque is maximal for a respective absolute value of the space vector.

Preferably, in the second operating state, the setpoint for the d-component has a higher value than the d-component of the MTPC operating point that is assigned to the desired torque and/or the setpoint for the q-component has a lower value than the q-component of the MTPC operating point that is assigned to the desired torque. At the same torque, the rotor losses are substantially decreasing with an increase of the value of the d-component and with an decrease of the value of the q-component, whereas the stator losses are minimal at the MTPC operating point. Thus, an operating point can be identified, where the sum of stator losses and rotor losses is minimal at a certain torque. Such operating points are also named MTPL (maximum torque per losses) operating points and generally depend on the actual operating conditions of the electric machine. It has been found out that usually the MTPL operating points have a higher d-component than the MTPC operation points for a certain torque. Thus, at least within a certain range of values, the overall efficiency of the electric machine may be even increased by increasing the setpoint of the d-component or decreasing the setpoint of the q-component, respectively. Beyond the MTPL operating point, when the d-component increases, the stator losses increase as well but the rotor losses decrease.

It is furthermore preferred that, in the first operating mode, the pair of setpoints correspond to the MTPC operating point that is assigned to the desired torque. The first operating mode is preferably chosen for lower temperature ranges covering the first temperature. At these rotor temperatures, it may not be necessary to change from the well-established use of MTPC operating points as control strategy to the second operating mode with a higher d-component and a lower q-component since the temperature of the rotor is not in a critical range.

With regard to the drive device according to the invention, the power converter device may further be configured to evaluate a condition, according to which the temperature of the rotor reaches or exceeds a predetermined temperature threshold value being higher than the first temperature and lower than the second temperature. Then, the power converter device may be configured to operate according to the first operating mode if the condition is not fulfilled. Alternatively or additionally, the power converter device may be configured to operate according to the second operating mode if the condition is fulfilled. Evaluating the condition allows to clearly define a temperature range covering the first temperature, in which the first operating mode is applied, and a temperature range covering the second temperature, in which the second operating mode is applied. The threshold value is typically chosen with regard to the specific design of the electric machine, particularly taking the material parameters of the rotor into account. It is, thus, proposed to choose the threshold value such that there is a certain margin to a temperature, at which an actual derating of the rotor is to be expected.

Desirably, in the second operating mode, upon receiving an information state representing a temperature of the rotor being higher than the second temperature, the setpoint for d-component is determined with a higher value and the setpoint for the q-component is determined with a lower value than upon receiving the second information state. Alternatively or additionally, in the second operating mode, upon receiving an information state representing a temperature of the rotor being lower than the second temperature and higher than the first temperature, particularly higher than the threshold value, the setpoint for d-component may be determined with a lower value and the setpoint for the q-component may be determined with a higher value than upon receiving the second information state. Accordingly, when the second operating mode is applied, the setpoint for the d-component or the setpoint for the q-component, respectively, may be adapted to other temperatures than the second temperature. According to specific embodiments, the pair of setpoints may be determined by evaluating an arithmetic function that depends on the desired torque and the temperature of the rotor or by using a look-up table that assigns pairs of setpoints to certain intervals of the desired torque and the temperature of the rotor.

With regard to the drive device according to the invention, in the second operating mode, the pair of setpoints may lie within a predetermined operating range of the machine characteristics. In other words, the determination of the pairs setpoints may be restricted to an operating range defined in advance. Particularly, the predetermined operating range excludes those pairs of setpoints that have a d-component being so high that the corresponding amount of stator losses does not justify a further decrease of the q-component or the rotor losses, respectively.

Preferably, the operating range is chosen such that an efficiency measure for all operating points inside the operating range does not undercut a maximum of the efficiency measure assigned to the same torque as the respective operating point more than 10 percent, preferably 5 percent, more preferably 2 percent. Thereby, the decrease of the q-component in the second operating mode may be restricted by considering an acceptable amount of decrease in efficiency of the electric machine. A corresponding efficiency measure may be a ratio of a mechanical output power of the electric machine to an electric input power of the electric machine. For example, the operating range may be determined by experiment on a testing bench with a reference machine or by simulation, therein determining the efficiency and defining corresponding boundaries of the operating range.

It is further possible that the operating range is bounded by a, in particular linear, combination of the d-component and the q-component and/or by a predefined maximum of the absolute value of the space vector. Restricting the operating range in this way has been identified as a suitable approach to exclude operating points, where a further increase of the d-component counteracts the benefits of reduced rotor losses.

In particular, the absolute value of the space vector is the square root of the sum of the square of the d-component and the square of q-component.

Preferably, the temperature determination device comprises a temperature sensor configured to provide sensor signals. The temperature sensor may be arranged at the rotor, the temperature determination device being configured to provide the sensor signals as temperature information. Thus, the temperature of the rotor may be measured directly at the rotor.

However, as it may be difficult to reliably arrange the temperature sensor at a rotating part of the electric machine, the temperature sensor may alternatively be arranged at the electric machine, preferably at the stator, wherein the temperature determination device may be configured to estimate the temperature of the rotor based on the sensor signals and on a thermal model of the electric machine. Such thermal models allow to derive an estimation of the temperature of the rotor from one or multiple temperatures at other positions of the electric machine by taking into account thermal resistances and capacitances acting between the position of the temperature sensor and the rotor. It should be noted that due to certain error margins when estimating the temperature of the rotor, conventional electric drives restrict the stator current already at relatively low temperatures of the rotor so that the drive device according to the invention allows to provide the desired torque under significantly extended operating conditions.

The operating strategy set out before is particularly efficient when the electric machine is an induction motor. The rotors of an induction motor can be cooled actively only with very high effort, so that an improvement of the performance can be achieved without additional costs for an active rotor cooling. Particularly with regard to induction motors having a rotor with a rotor cage made of aluminum, the effect of the inventive operating strategy is highly significant due to the high losses when using this material.

The above object is further solved by an electric vehicle, comprising a drive device according to the invention, the drive device being configured to propel the electric vehicle.

The electric vehicle may comprise a DC voltage source, such as a battery, supplying the power converter device. Then, the electric vehicle may be battery electric vehicle (BEV). Also, the electric vehicle may comprise a combustion engine, therein forming a hybrid vehicle. Further, the electric vehicle may comprise a fuel cell as DC voltage source.

Preferably, the electric vehicle may further comprise a control device configured to provide the torque command to the input of the drive device. The control device may be configured to evaluate a position of an accelerator pedal of the electric vehicle and to provide the torque command depending on the position.

The above object is further solved by a method for operating a drive device in an electric vehicle, the drive device comprising: an electric machine with a stator and with a rotor being arranged rotatably relative to the stator; a temperature determination device; and a power converter device configured to provide a multiphase current to the stator, having an input and being operable according to a first operating mode and a second operating mode; the multiphase current being representable by a space vector with a d-component and a q-component in a rotor flux oriented coordinate system; the electric machine having machine characteristics, according to which one value of a torque provided by the rotor is assigned to each one of multiple operating points, operating point being a pair of values of the d-component and the q-component; the method comprising steps of: determining, by the temperature determination device, a temperature information being representative of a temperature of the rotor, the temperature information having at least two information states, a first one of the information states being representative of a first temperature and a second one of the information states being representative of second temperature being higher than the first temperature; receiving, at the input of the power converter device, a torque command representing a desired torque to be provided by the rotor; determining, by the power converter device, a pair of setpoints for the d-component and the q-component corresponding to one of the operating points that is assigned to the desired torque, wherein, upon receiving the first information state, the pair of setpoints is determined according to the first operating mode, and, upon receiving the second information state, the pair of setpoints is determined according to the second operating mode, in which the setpoint for the d-component has a higher value than the setpoint for the d-component that is determined in the first operating mode at the desired torque and in which the setpoint for the q-component has a lower value than the setpoint for the q-component that is determined in the first operating mode at the desired torque; and generating, by the power converter device, the multiphase current depending on the pair of setpoints.

All statements referring to the drive device apply analogous to the electric vehicle and the method according to the invention so that the advantages described with regard to the drive device can be achieved by the electric vehicle and the method as well.

Particularly, the step of determining the pair of setpoints may comprise evaluating a condition, according to which the temperature of the rotor reaches or exceeds a predetermined temperature threshold value being higher than the first temperature and lower than the second temperature, and to operate according to the first operating mode if the condition is not fulfilled and/or to operate according to the second operating mode if the condition is fulfilled.

Furter, the step of determining the temperature information may comprise providing the sensor signals as temperature information or estimating the temperature of the rotor based on the sensor signals and on a thermal model of the electric machine.

### BRIEF DESCRIPTION OF THE DRAWINGS

Further details and advantages of the invention are disclosed in the following, wherein reference is made to the drawings. The drawings are schematical and show:

FIG. 1 a block diagram of an embodiment of the drive device according to the invention;

FIG. 2 a diagram of machine characteristics of the electric machine according to the embodiment;

FIG. 3 diagrams of losses and efficiency over the d-component of the space vector according to the embodiment;

FIG. 4 a block diagram of an embodiment of an electric vehicle according to the invention; and

FIG. 5 a flow chart of an embodiment of the operating method according to the invention.

### DETAILED DESCRIPTION

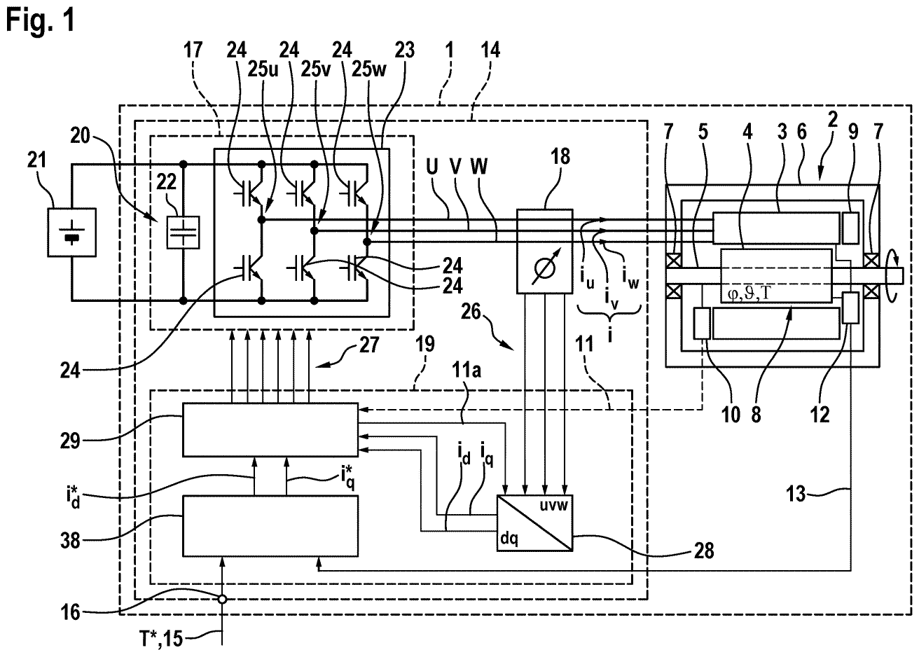

FIG. 1 is a block diagram of an embodiment of a drive device 1.

The drive device 1 comprises an electric machine 2 with a stator 3 and with a rotor 4 being arranged rotatably relative to the stator 2. The electric machine 2 is an induction motor with a rotor formed by an aluminum cage.

In more detail, the electric machine 2 also comprises a shaft 5 connected in a torque-proof manner to the rotor 4 and a machine housing 6, which accommodated the components of the electric machine 2. The shaft 5 is supported by bearings 7 being affixed to the machine housing 6 and an air gap 8 is formed between the rotor 4 and the stator 3. In the present embodiment, the rotor 4 is passively cooled by thermal paths to the stator housing 6 via the bearings 7 and the shaft 5 on the one hand and via the air gap 8 and the stator 2 on the other hand. Optionally, the stator 3 is actively cooled by means of a cooling device 9. Further, there is provided a rotor position sensor 10 of the drive device 1 configured to determine a rotor angle information 11 representing an angular position φ of the rotor 4.

The drive device 1 further comprises a temperature determination device 12 configured to determine a temperature information 13 being representative of a temperature ϑ of the rotor 4. Exemplarily, the temperature determination device 12 comprises a temperature sensor being arranged at the stator 3 or the machine housing 6 and configured to provide sensor signals. A signal processing member of the temperature determination device 12 may be disposed outside the machine housing 6. The temperature determination device 12 is configured to estimate the temperature of the rotor 4 based on the sensor signals and on a thermal model of the electric machine 2.

Also, the drive device 1 comprises a power converter device 14 configured to provide a multiphase current i to the stator 3. The multiphase current i is representable by a space vector with a d-component and a q-component. For receiving a torque command 15 representing a desired torque T* to be provided by the rotor 4, the power converter device 14 comprises an input 16. The power converter device 14 is configured to determine a pair of setpoints for the d-component

$${i}_{d}^{*}$$

and the q-component

$${i}_{q}^{*}$$

and to generate the multiphase current i depending on the pair of setpoints

$${i}_{d}^{*} , {i}_{q}^{*} .$$

In more detail, the power converter device 14 comprises a power section 17 for providing the multiphase current i to the electric machine 2, a current measurement section 18 and a control section 19.

The power section 17 comprises a DC link 20 configured to be connected to an external DC voltage source 21, such as a vehicle high-voltage battery. The power section 17 is configured to obtain a DC voltage of, e.g., 800 V from the DC voltage source 21. Further, the power section 17 comprises a DC link capacitor 22 and an inverter circuit 23 connected to the DC link capacitor 22. The inverter circuit 23 comprises a plurality of semiconductor switching elements 24, exemplarily insulated gate bipolar transistors (IGBT), which are interconnected to a half-bridge 25u, 25v, 25w for each phase U, V, W of the multiphase current i.

The current measurement section 18 is configured to determine a current information 26 representing the multiphase current i. In the present embodiment, the current measurement section 18 is connected between the power section 17 and the electric machine 2. Further, it is configured to provide the current information 26 such that it represents the currents iᵤ, iᵥ, i_{w} of each phase U, V, W.

The control section 19 is configured to generate switching signals 27 for turning on and off the switching elements 24 of the power section 17, wherein the connection between the control section 19 and the respective switching elements 24 is not shown in detail in FIG. 1 for reasons of clarity. The control section 19 is configured to provide the switching signals 27 based on field-oriented control. In particular, the control section 19 comprises a transformation subsection 28 configured to transform the current information 26 and a transformation angle 11a into an actual d-current value i_{d} and into an actual q-current value i_{g}. A regulator subsection 29 of the control section 19 is configured to generate the switching signals 27 depending on the pair of setpoints

$${i}_{d}^{*} , {i}_{q}^{*} ,$$

the actual u-current value i_{d}, and the actual q-current value i_{q}. Also, the regulator subsection 29 is configured to generate the switching signals 27 based on a transformation being inverse to the transformation performed by the transformation subsection 28. The regulator subsection 29 is further configured to determine the transformation angle 11a from the rotor angle information 11 and to provide it to the transformation subsection 28.

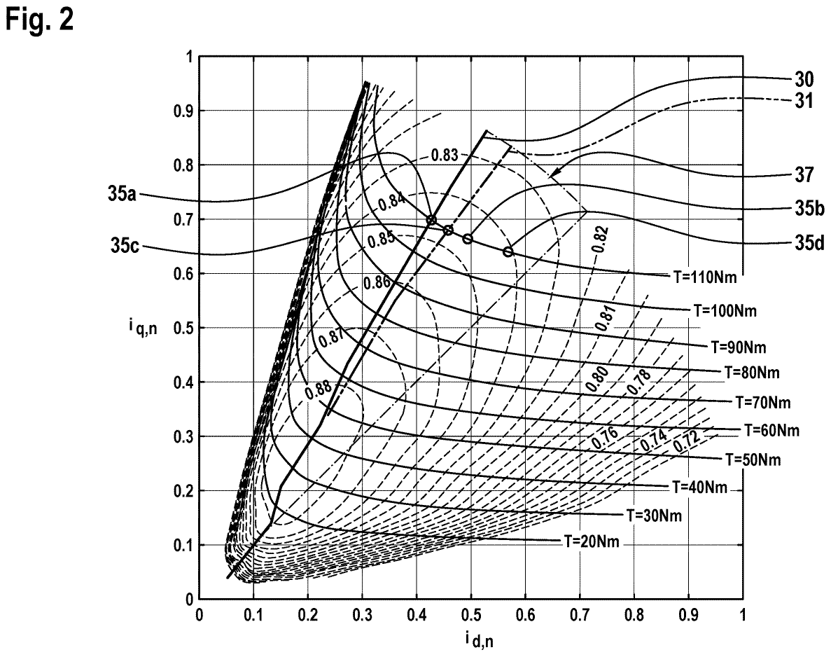

FIG. 2 is a diagram of machine characteristics of the electric machine 2 according to the embodiment. The diagram has a horizontal axis denoting normalized values of the d-component i_{d,n} of the multiphase current i and a vertical axis denoting normalized values of the q-component i_{q,n} of the multiphase current i.

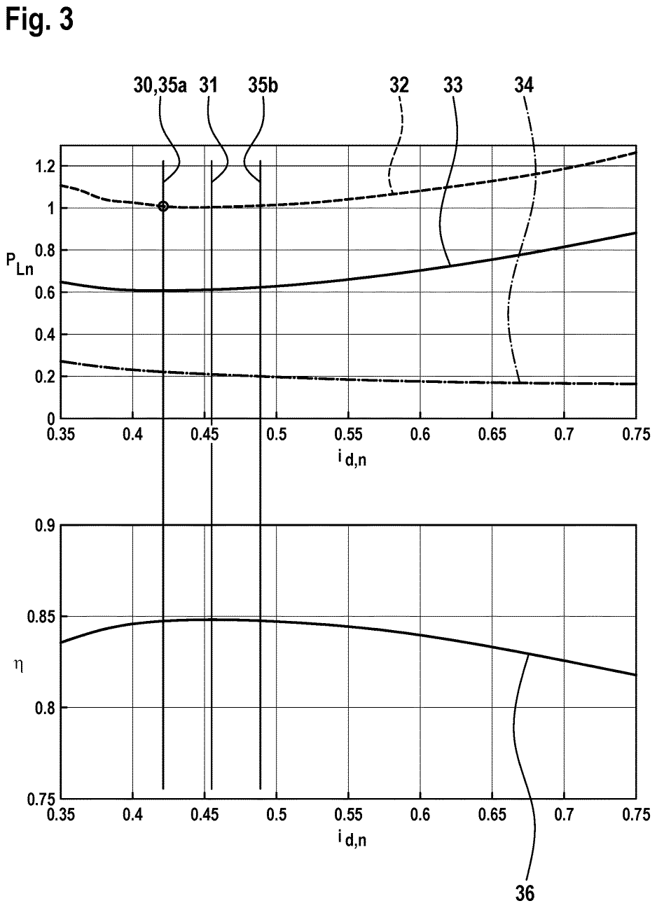

According to the machine characteristics, one value of the torque T provided by the rotor 4 is assigned to each one of multiple operating points. Each operating point is a pair of values of the d-component and the q-component of the space vector. Further, FIG. 2 shows a curve denoting MTPC operating points 30 each assigned to a respective value of the torque T. The MTPC operating points 30 comprise those operating points, at which the torque is maximal for a respective absolute value of the space vector. Also, in FIG. 2 there is shown a curve denoting MTPL operating points 31, at which a sum 32 of stator losses 33 and rotor losses 34 (see FIG. 3) is minimal at each value of the torque T. By dashed lines in FIG. 2, there are further shown isolines of an efficiency measure, being chosen exemplarily as a ratio of a mechanical output power of the electric machine 2 to an electric input power of the electric machine 2.

The power converter device 14 is configured to determine the pair of setpoints i_{d}^{*}, i_{q}^{*} for the d-component and the q-component corresponding to one of the operating points that is assigned to the desired torque T* represented by the received torque command 15. Therein, upon receiving a first information state of the temperature information 13 representing a first temperature 21 of the rotor 4, the pair of setpoints

$${i}_{d}^{*} , {i}_{q}^{*}$$

is determined according to the first operating mode. Upon receiving a second information state of the temperature information 13 representing a second temperature ϑ₂ that is higher than the first temperature ϑ₁ the pair of setpoints

$${i}_{d}^{*} , {i}_{q}^{*}$$

is determined according to the second operating mode. The second operating mode differs from the first operating mode in that the setpoint

$${i}_{d}^{*}$$

for the d-component has a higher value than the setpoint

$${i}_{d}^{*}$$

for the d-component that is determined in the first operating mode at the desired torque T* and in that the setpoint

$${i}_{q}^{*}$$

for the q-component has a lower value than the setpoint

$${i}_{q}^{*}$$

for the q-component that is determined in the first operating mode at the desired torque T*.

With regard to the FIG. 2, assume that the torque command 15 requests a torque of 110 Nm. When the temperature information 13 has the first information state, i.e., a relatively low temperature 21 of the rotor 4, the power converter device 14 operates in the first operating mode and determines operating point 35a as pair of setpoints

$${i}_{d}^{*} , {i}_{q}^{*} ,$$

which is an MTPC operating point 30. Based on the same torque command 15 of 110 Nm and the second information state representing the higher second temperature ϑ₂, the power converter device 14 operates in the second operating mode and determines operating point 35b as pair of setpoints

$${i}_{d}^{*} , {i}_{q}^{*} .$$

As can be seen, when following the curve denoting the requested torque of 110 Nm, the setpoint

$${i}_{d}^{*}$$

for the d-component has a higher value at operating point 35b than at operating point 35a, whereas the setpoint

$${i}_{q}^{*}$$

has a lower value at operating point 35b than at operating point 35a.

FIG. 3 shows diagrams of losses P_{Ln} and the efficiency measure η over the d-component of the space vector according to the embodiment. Therein, the upper diagram shows the stator losses 33, the rotor losses 34 and their sum 32 over the normalized values of the d-component i_{d,n} and the lower diagram shows the efficiency measure 36 over the normalized values of the d-component i_{d,n}. Both diagrams refer to the above torque of 110 Nm at a rotational speed of 3.000 min⁻¹ of the rotor 4. Note that these values are chosen for illustrative purposes only.

As can be seen in FIG. 3, by increasing the d-component, the rotor losses 34 can be decreased due to a corresponding reduction of the q-component. The stator losses 33 have, however, a minimum at the MTPC operating point 30. Correspondingly, the sum 32 of stator losses 33 and rotor losses 34 has a minimum at a higher value of the d-component corresponding to the MTPL operating point 31, which also corresponds to a maximum of the efficiency measure 36. That is, at the higher second temperature 2 of the rotor 4, the operating point 35b is determined so as to reduce the rotor losses 34 and a resulting heat generation inside the rotor 4. As can be seen at operating point 35b, the same value of the efficiency measure 36 can be achieve as at operating point 35a for the first temperature ϑ₁. The correspondingly higher stator losses 33 at the second operating point 35b can accepted as the stator 3 is actively cooled by the cooling device 9, whereas the rotor 4 is merely passively cooled by the thermal paths to the stator housing 6.

In the following, the determination of the pair of setpoints

$${i}_{d}^{*} , {i}_{q}^{*}$$

for other temperatures than the first and second temperature ϑ₁, ϑ₂ is described.

According to this embodiment, the power converter device 14 is further configured to evaluate a condition, according to which the temperature ϑ of the rotor 4 reaches or exceeds a predetermined temperature threshold value ϑₜₕᵣ being higher than the first temperature ϑ₁ and lower than the second temperature ϑ₂. The power converter device 14 is configured to operate according to the first operating mode if the condition is not fulfilled and to operate according to the second operating mode if the condition is fulfilled. I.e., for a temperature ϑ<ϑₜₕᵣ, the first operating mode is chosen, whereas for a temperature ϑ>ϑₜₕᵣ the second operating mode is chosen.

In the first operating mode, the pair of setpoints correspond to the MTPC operating point 30 that is assigned to the desired torque T*. That is, as long at the temperature of the rotor 4 does not reach or exceed the predetermined temperature threshold value ϑₜₕᵣ, the power converter device uses the MTPC operating point 30 assigned to the desired torque T* as pair of setpoints

$${i}_{d}^{*} , {i}_{q}^{*} .$$

In the second operating mode, upon receiving an information state of the temperature information 13 representing a third temperature ϑ₃ of the rotor being lower than the second temperature ϑ₂ and higher than the temperature threshold value ϑₜₕᵣ, the setpoint

$${i}_{d}^{*}$$

for the ad-component is determined with a lower value and the setpoint

$${i}_{q}^{*}$$

for the q-component is determined with a higher value than upon receiving the second information state. Exemplarily, the pair of setpoints

$${i}_{d}^{*} , {i}_{q}^{*}$$

corresponds to operating point 35c in FIG. 2. Upon receiving an information state representing a fourth temperature ϑ₄ being higher than the second temperature ϑ₂, the setpoint

$${i}_{d}^{*}$$

for d-component is determined with a higher value and the setpoint for the q-component

$${i}_{q}^{*}$$

is determined with a lower value than upon receiving the second information state. Exemplarily, the pair of setpoints corresponds to

$${i}_{d}^{*} , {i}_{q}^{*}$$

corresponds to operating point 35d in FIG. 2.

That is, in the second operating mode, within an interval of temperatures ϑₜₕᵣ<ϑ₃<ϑ₂<ϑ₄ the setpoint

$${i}_{d}^{*}$$

for the d-component has a higher value for a respective higher temperature and the setpoint

$${i}_{q}^{*}$$

for the q-component has a lower value for respective higher temperature. In order to determine the pair of setpoints

$${i}_{d}^{*} , {i}_{q}^{*}$$

for temperatures ϑ>ϑₜₕᵣ, the power converter device 14 evaluates an arithmetic function that depends on the desired torque T* and the temperature ϑ of the rotor 4.

Also, with regard to the second operating mode, it is provided that the pair of setpoints

$${i}_{d}^{*} , {i}_{q}^{*}$$

lies within a predetermined operating range 37 (see FIG. 2) of the machine characteristics. The operating range is chosen such that an efficiency measure for all operating points inside the operating range does not undercut a maximum of the efficiency measure 36 assigned to the same torque T as the respective operating point more than a specified percentage of, e.g., 10, 5 or 2 percent. Therein, the operating range 37 is bounded by a linear combination of the d-component and the q-component and by a predefined maximum of the absolute value of the space vector. Therein, the boundary forms an approximate L-shape or an approximate circular sector as can be seen in FIG. 2.

For determining the pair of setpoints

$${i}_{d}^{*} , {i}_{q}^{*}$$

as described afore, the control section 19 comprises a determination subsection 38 configured to determine the pair of setpoints

$${i}_{d}^{*} , {i}_{q}^{*}$$

depending on the temperature information 13 and the torque command 15. That is, the determination subsection 38 is configured to obtain the temperature information 13 from the temperature determination device 12, to obtain the torque command 15 from the input 16 and to provide the determined pairs of setpoints

$${i}_{d}^{*} , {i}_{q}^{*}$$

to the regulator subsection 29.

According to this embodiment the control section 19 including its subsections 28, 29, 38 is implemented by a single piece of hardware such as a microcontroller or an FPGA.

Although not shown in FIG. 1 for reasons of simplicity, the drive device 1 comprises a gear box being mechanically coupled to the shaft 5. The gear box connects the shaft of the electric machine via multiple gears with a wheel hub. The electric machine 2, the temperature determination device 12 and the power converter device 14 and the gear box are arranged within an integral housing.

According to a further embodiment, the temperature sensor is arranged at the rotor 4 and the temperature determination device 12 is configured to provide the sensor signals as temperature information 13.

According to a further embodiment, the switching elements 24 are insulated gate field-effect transistors (IGFET) such as silicon carbide-based metal-oxide-semiconductor field-effect transistors (SiC-MOSFET) or gallium-nitride-based field effect transistors (GaN-FET).

According to a further embodiment, instead of evaluating an arithmetic function for determining the pair of setpoints

$${i}_{d}^{*} , {i}_{q}^{*}$$

for further temperatures ϑ>ϑₜₕᵣ, the power converter device 14 or the determination subsection 38, respectively, uses a look-up table that assigns pairs of setpoints

$${i}_{d}^{*} , {i}_{q}^{*}$$

to certain intervals of the desired torque T* and the temperature ϑ of the rotor 4.

According to a further embodiment, the subsections 28, 29, 38 of the control section 19 are implemented by multiple and/or distributed pieces of hardware being connected physically with each other.

According to a further embodiment, the rotor position sensor 10 is omitted and the transformation angle 11a is determined by the regulator subsection 29 based on internal data or, in other words, sensorless.

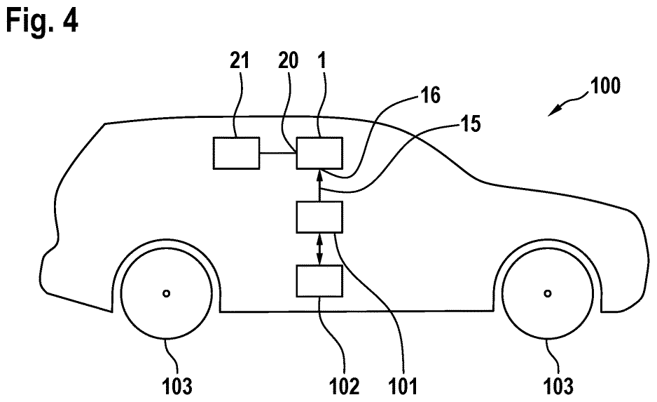

FIG. 4 is a block diagram of an embodiment of an electric vehicle 100.

The electric vehicle 100 comprises a drive device 1 according to one of the above embodiments, which is configured to propel the electric vehicle 100. The electric vehicle 100 further comprises a control device 101 configured to provide the torque command 15 to the input 16 of the drive device 1. Therein, the control device 101 may be configured to evaluate a position of an accelerator pedal 102 of the electric vehicle 100 and to provide the torque command depending on the position. Further, the vehicle 100 comprises the DC voltage source 21 connected to the DC link 20 of the drive device 1.

The electric vehicle 100 comprises wheels 103 being directly or indirectly, e.g., via a transmission, coupled with the drive device 1 so as to rotate the wheels 103.

According to the embodiment, the electric vehicle 100 is a battery electric vehicle (BEV). Alternatively, the electric vehicle 100 may additionally comprise a combustion engine, therein forming a hybrid vehicle. Further, the electric vehicle 100 may comprise a fuel cell as DC voltage source 21 supplying the power convert device 1.

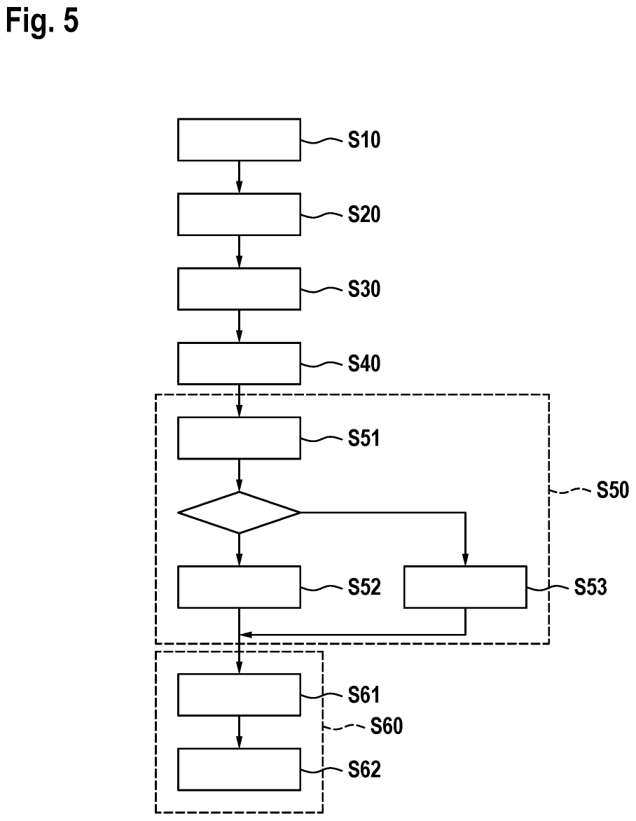

FIG. 5 is a flow chart of an embodiment of a method for operating a drive device 1 in an electric vehicle 100 such as the vehicle 100 described before.

The method comprises a step S10 of determining, by the temperature determination device 12, the temperature information 13 being representative of the temperature of the rotor 4.

The method comprises a further step S20 of receiving, at the input 16 of the power converter device 14, the torque command 15 representing the desired torque T* to be provided by the rotor 4.

The method comprises an optional further step S30 of determining, by the rotor position sensor 10, a rotor angle information 11 representing an angular position q of the rotor 4.

The method comprises a further step S40 of determining, by the current measurement section 18, a current information 26 representing the multiphase current i.

The method comprises a further step S50 of determining, by the power converter device 14, particularly by the control section 19 or its determination subsection 38, respectively, a pair of setpoints

$${i}_{d}^{*} , {i}_{q}^{*}$$

for the d-component and the q-component corresponding to one of the operating points that is assigned to the desired torque T*, wherein, upon receiving the first information state, the pair or setpoints

$${i}_{d}^{*} , {i}_{q}^{*}$$

is determined according to the first operating mode, and, upon receiving the second information state, the pair of setpoints

$${i}_{d}^{*} , {i}_{q}^{*}$$

is determined according to the second operating mode, in which the setpoint

$${i}_{d}^{*} ,$$

for the d-component has a higher value than the setpoint

$${i}_{q}^{*}$$

for the d-component that is determined in the first operating mode at the desired torque T* and in which the setpoint

$${i}_{q}^{*}$$

for the q-component has a lower value than the setpoint

$${i}_{q}^{*}$$

for the q-component that is determined in the first operating mode at the desired torque.

Step S50 comprises a substep S51 of evaluating, by the power converter device 14, particularly by the control section 19 or its determination subsection 38, respectively, a condition, according to which the temperature of the rotor 4 reaches or exceeds the predetermined temperature threshold value being higher than the first temperature and lower than the second temperature.

The method branches to a substep S52 of step S50 if the condition is not fulfilled and to a substep S53 of step S50 if the condition is fulfilled. According to substep S52 the power converter device 14 is operated according to the first operating mode as set out with regard to the embodiments of the drive device 1. According to substep S53, the power converter device 14 is operated according to the second operating mode as set out with regard to the embodiments of the drive device 1.

The method further comprises a step S60 subsequent to step S50 or substeps S52 or S53, respectively. Step S60 comprises generating, by the power converter device 14, the multiphase current i depending on the pair of setpoints

$${i}_{d}^{*} , {i}_{q}^{*} .$$

Step S60 comprises substep S61 of generating, by the control section 19, switching signals 27 for turning on and off the switching elements 24 of the power section 17 depending on rotor angle information 11, the current information 26 and the pair of setpoints

$${i}_{d}^{*} , {i}_{q}^{*} .$$

Substep S61 comprises determining, by the regulator subsection 29 a transformation angle 11a, in particular based on the rotor angle information 11 or based on internal data. Further, substep S61 comprises transforming, by the transformation sub section 28, the current information 26 and the transformation angle 11a into an actual d-current value i_{d} and into an actual q-current value i_{q} and generating, by the regulator subsection 29, the switching signals 27 depending on the pair of setpoints

$${i}_{d}^{*} , {i}_{q}^{*} ,$$

the actual d-current value i_{d}, the actual q-current value i_{q} and the transformation angle 11a.

Further, step S60 comprises substep S62 of generating, by the power section 17 or its inverter circuit 23, respectively, the multiphase current i depending on the switching signals 27.

1. Drive device for an electric vehicle, comprising:
an electric machine with a stator and with a rotor-being arranged rotatably relative to the stator;
a temperature determination device configured to determine a temperature information being representative of a temperature (ϑ) of the rotor, the temperature information having at least two information states, a first one of the information states being representative of a first temperature and a second one of the information states being representative of a second temperature being higher than the first temperature; and
a power converter device configured to provide a multiphase current (i) to the stator, having an input for a torque command representing a desired torque (T*) to be provided by the rotor and being operable according to a first operating mode and according to a second operating mode, the multiphase current (i) being representable by a space vector with a d-component and a q-component in a rotor flux oriented coordinate system;
the electric machine having machine characteristics, according to which one value of a torque (T) provided by the rotor is assigned to each one of multiple operating points, each operating point being a pair of values of the d-component and the q-component, the power converter device being configured to receive the torque command and to determine a pair of setpoints
$$( {i}_{d}^{*} , {i}_{q}^{*} )$$
for the d-component and the q-component corresponding to one of the operating points that is assigned to the desired torque (T*), wherein, upon receiving the first information state, the pair of setpoints
$$( {i}_{d}^{*} , {i}_{q}^{*} )$$
is determined according to the first operating mode, and, upon receiving the second information state, the pair of setpoints
$$( {i}_{d}^{*} , {i}_{q}^{*} )$$
is determined according to the second operating mode, in which the setpoint
$$( {i}_{d}^{*} )$$
for the d-component has a higher value that the setpoint
$$( {i}_{d}^{*} )$$
for the d-component that is determined in the first operating mode at the desired torque (T*) and in which the setpoint
$$( {i}_{q}^{*} )$$
for the q-component has a lower value than the setpoint
$$( {i}_{q}^{*} )$$
for the q-component that is determined in the first operating mode at the desired torque (T*), wherein the power converter device is further configured to generate the multiphase current depending on the pair of setpoints
$$( {i}_{d}^{*} , {i}_{q}^{*} ) .$$

2. Drive device according to claim 1, wherein
the machine characteristics have MTPC operating points assigned to a respective value of the torque (T).

3. Drive device according to claim 2, wherein
in the second operating state, the setpoint
$$( {i}_{d}^{*} )$$
for the d-component has a higher value than the d-component of the MTPC operating point that is assigned to the desired torque (T*) and/or the setpoint for the q-component
$$( {i}_{q}^{*} )$$
has a lower value than the q-component of the MTPC operating point that is assigned to the desired torque (T*).

4. Drive device according to claim 2, wherein
in the first operating mode, the pair of setpoints
$$( {i}_{d}^{*} , {i}_{q}^{*} )$$
correspond to the MTPC operating point that is assigned to the desired torque (T*).

5. Drive device according to claim 2, wherein
the MTPC operating points comprise those operating points, at which the torque (T) is maximal for a respective absolute value of the space vector.

6. Drive device according to claim 1, wherein
the power converter device is further configured to evaluate a condition, according to which the temperature (ϑ) of the rotor reaches or exceeds a predetermined temperature threshold value being higher than the first temperature and lower than the second temperature, and to operate according to the first operating mode if the condition is not fulfilled and/or to operate according to the second operating mode if the condition is fulfilled.

7. Drive device according to claim 1, wherein
in the second operating mode, upon receiving an information state representing a temperature (ϑ) of the rotor being higher than the second temperature, the setpoint
$$( {i}_{d}^{*} )$$
for d-component is determined with a higher value and the setpoint
$$( {i}_{q}^{*} )$$
for the q-component is determined with a lower value than upon receiving the second information state and/or, upon receiving an information state representing a temperature (ϑ) of the rotor being lower than the second temperature and higher than the first temperature, the setpoint for d-component
$$( {i}_{d}^{*} )$$
is determined with a lower value and the setpoint for the q-component
$$( {i}_{q}^{*} )$$
is determined with a higher value than upon receiving the second information state.

8. Drive device according to claim 1, wherein
in the second operating mode, the pair of setpoints
$$( {i}_{d}^{*} , {i}_{q}^{*} )$$
lies within a predetermined operating range of the machine characteristics.

9. Drive device according to claim 8, wherein
the operating range is chosen such that an efficiency measure for all operating points inside the operating range does not undercut a maximum of the efficiency measure assigned to the same torque (T) as the respective operating point more than 10 percent, preferably 5 percent, more preferably 2 percent.

10. Drive device according to claim 9, wherein
the efficiency measure is a ratio of a mechanical output power of the electric machine to an electric input power of the electric machine.

11. Drive device according to claim 8, wherein
the operating range is bounded by a combination of the d-component and the q-component and/or by a predefined maximum of the absolute value of the space vector.

12. Drive device according to claim 1, wherein
the temperature determination device comprises a temperature sensor configured to provide sensor signals,
the temperature sensor being arranged at the rotor, the temperature determination device being configured to provide the sensor signals as temperature information, or
the temperature sensor being arranged at the electric machine preferably at the stator, the temperature determination device being configured to estimate the temperature (ϑ) of the rotor based on the sensor signals and on a thermal model of the electric machine.

13. Drive device according to claim 1, wherein
the electric machine is an induction motor.

14. Electric vehicle, comprising a drive device according to claim 1, the drive device being configured to propel the electric vehicle.

15. Method for operating a drive device in an electric vehicle, the drive device comprising: an electric machine with a stator and with a rotor being arranged rotatably relative to the stator; a temperature determination device; and a power converter device configured to provide a multiphase current (i) to the stator, having an input and being operable according to a first operating mode and a second operating mode; the multiphase current (i) being representable by a space vector with a d-component and a q-component in a rotor flux oriented coordinate system; the electric machine having machine characteristics, according to which one value of a torque (T) provided by the rotor is assigned to each one of multiple operating points, each operating point being a pair of values of the d-component and the q-component; the method comprising steps of:
determining, by the temperature determination device, a temperature information being representative of a temperature (ϑ) of the rotor, the temperature information having at least two information states, a first one of the information states being representative of a first temperature and a second one of the information states being representative of second temperature being higher than the first temperature;
receiving, at the input of the power converter device, a torque command representing a desired torque (T*) to be provided by the rotor;
determining, by the power converter device, a pair of setpoints
$$( {i}_{d}^{*} , {i}_{q}^{*} )$$
for the d-component and the q-component corresponding to one of the operating points that is assigned to the desired torque (T*), wherein, upon receiving the first information state, the pair of setpoints
$$( {i}_{d}^{*} , {i}_{q}^{*} )$$
is determined according to the first operating mode, and, upon receiving the second information state, the pair of setpoints
$$( {i}_{d}^{*} , {i}_{q}^{*} )$$
is determined according to the second operating mode, in which the setpoint
$$( {i}_{d}^{*} )$$
for the d-component has a higher value than the setpoint for the d-component
$$( {i}_{d}^{*} )$$
that is determined in the first operating mode at the desired torque (T*) and in which the setpoint for the q-component
$$( {i}_{q}^{*} )$$
has a lower value that the setpoint for the q-component
$$( {i}_{q}^{*} )$$
that is determined in the first operating mode at the desired torque (T*); and
generating, by the power converter device, the multiphase current (i) depending on the pair of setpoints
$$( {i}_{d}^{*} , {i}_{q}^{*} ) .$$

16. Drive device according to claim 3, wherein
in the first operating mode, the pair of setpoints
$$( {i}_{d}^{*} , {i}_{q}^{*} )$$
correspond to the MTPC operating point that is assigned to the desired torque (T*).

17. Drive device according to claim 3, wherein
the MTPC operating points comprise those operating points, at which the torque (T) is maximal for a respective absolute value of the space vector.

18. Drive device according to claim 2, wherein
the power converter device is further configured to evaluate a condition, according to which the temperature (ϑ) of the rotor reaches or exceeds a predetermined temperature threshold value being higher than the first temperature and lower than the second temperature, and to operate according to the first operating mode if the condition is not fulfilled and/or to operate according to the second operating mode if the condition is fulfilled.

19. Drive device according to claim 2, wherein
in the second operating mode, upon receiving an information state representing a temperature (ϑ) of the rotor being higher than the second temperature, the setpoint
$$( {i}_{d}^{*} )$$
for d-component is determined with a higher value and the setpoint
$$( {i}_{q}^{*} )$$
for the q-component is determined with a lower value than upon receiving the second information state and/or, upon receiving an information state representing a temperature (ϑ) of the rotor being lower than the second temperature and higher than the first temperature, the setpoint for d-component
$$( {i}_{d}^{*} )$$
is determined with a lower value and the setpoint for the q-component
$$( {i}_{q}^{*} )$$
is determined with a higher value than upon receiving the second information state.

20. Drive device according to claim 2, wherein
in the second operating mode, the pair of setpoints
$$( {i}_{d}^{*} , {i}_{q}^{*} )$$
lies within a predetermined operating range of the machine characteristics.
